(19) United States
(12) Patent Application Publication
(10) Pub. No.: US 2025/0371766 A1
(43) Pub. Date: Dec. 4, 2025

(54) EFFECT PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventor: Pengjing Song, Beijing (CN)

(21) Appl. No.: 18/875,581

(22) PCT Filed: Aug. 30, 2023
(86) PCT No.: PCT/CN2023/115649

§ 371 Date: Dec. 16, 2024

(30) Foreign Application Priority Data
Sep. 8, 2022 (CN) 202211097817.6

(51) Int. Cl. G06T 11/60

(52) U.S. Cl. CPC G06T 11/60

(57) ABSTRACT

Embodiments of the present disclosure provide a method and apparatus, an electronic device, and a storage medium for effect processing. The method includes: in response to an effect triggering operation, obtaining an original picture, wherein at least one effect configuration identifier is displayed in the original picture; and receiving an identifier selection operation for the at least one effect configuration identifier to display an effect picture corresponding to a selected effect configuration identifier in the original picture.

### CROSS-REFERENCE TO RELATED APPLICATION(S)

This application claims priority to Chinese Patent Application No. 202211097817.6, filed with the China National Intellectual Property Administration on Sep. 8, 2022, the disclosure of which is incorporated herein by reference in its entirety.

### FIELD

Embodiments of the present disclosure relate to a computer application technology, and for example, to a method, an apparatus, an electronic device, and a storage medium for effect processing.

### BACKGROUND

Various short videos are constantly emerging on webpages and application programs. Many short videos attract the attention of users by adding effects. Although there are more and more types of effects, there are still many short videos that are added with the same type of effect.

### SUMMARY

The present disclosure provides a method and an apparatus, an electronic device, and a storage medium for effect processing to achieve a technical effect of generating a personalized effect picture according to a user interaction operation.

In a first aspect, the embodiments of the present disclosure provide a method for effect processing. The method includes:
in response to an effect triggering operation, obtaining an original picture, wherein at least one effect configuration identifier is displayed in the original picture; and
receiving an identifier selection operation for the at least one effect configuration identifier to display an effect picture corresponding to a selected effect configuration identifier in the original picture.

In a second aspect, the embodiments of the present disclosure provide an apparatus for effect processing. The apparatus includes:
an original picture obtaining module, configured to in response to an effect triggering operation, obtain an original picture, wherein at least one effect configuration identifier is displayed in the original picture; and
an effect picture display module, configured to: receive an identifier selection operation for the at least one effect configuration identifier to display an effect picture corresponding to a selected effect configuration identifier in the original picture.

In a third aspect, the embodiments of the present disclosure provide an electronic device. The electronic device includes:
one or more processors; and
a memory apparatus, configured to store one or more programs,
wherein the one or more programs, when performed by the one or more processors, cause the one or more processors to perform the method for effect processing provided in any of the embodiments of the present disclosure.

In a fourth aspect, the embodiments of the present disclosure further provide a storage medium including computer-executable instructions. When executed by a computer processor, causing the computer processor to perform the method for effect processing described in any of the embodiments of the present disclosure.

### BRIEF DESCRIPTION OF THE DRAWINGS

Throughout the accompanying drawings, identical or similar reference numerals represent identical or similar elements. It should be understood that the accompanying drawings are illustrative, and components and elements may not necessarily be drawn to scale.

FIG. 1 is a flowchart of a method for effect processing according to an embodiment of the present disclosure;

FIG. 2 is a flowchart of another method for effect processing according to an embodiment of the present disclosure;

FIG. 3 is a flowchart of still another method for effect processing according to an embodiment of the present disclosure;

FIG. 4 is a flowchart of yet another method for effect processing according to an embodiment of the present disclosure;

FIG. 5 is a flowchart of another method for effect processing according to an embodiment of the present disclosure;

FIG. 6 is a flowchart of an alternative example of a method for effect processing according to an embodiment of the present disclosure;

FIG. 7 is a schematic diagram of effect comparison of a visual interface before and after generation of an effect picture in a method for effect processing according to an embodiment of the present disclosure;

FIG. 8 is a schematic diagram of three selected effect configuration identifiers in a method for effect processing according to an embodiment of the present disclosure;

FIG. 9 is a schematic diagram of effect layers obtained after respectively processing effect material images corresponding to three selected effect configuration identifiers in a method for effect processing according to an embodiment of the present disclosure;

FIG. 10 is a schematic diagram of respective display positions in a method for effect processing according to an embodiment of the present disclosure, when effect layers corresponding to three selected effect configuration identifiers generate effect pictures;

FIG. 11 is a schematic diagram of effects of effect pictures generated in different image processing modes and corresponding to three selected effect configuration identifiers in a method for effect processing according to an embodiment of the present disclosure;

FIG. 12 is a schematic structural diagram of an apparatus for effect processing according to an embodiment of the present disclosure; and

FIG. 13 is a schematic structural diagram of an electronic device provided according to an embodiment of the present disclosure.

### DETAILED DESCRIPTION OF EMBODIMENTS

The embodiments of the present disclosure will be described below with reference to the accompanying drawings. Although the accompanying drawings show some embodiments of the present disclosure, it should be understood that the present disclosure can be implemented in various forms, and should not be explained as being limited to the embodiments stated herein. These embodiments are provided for understanding the present disclosure more thoroughly and completely. It should be understood that the accompanying drawings and embodiments of the present disclosure are only used for illustration, but are not intended to limit the protection scope of the present disclosure.

Multiple steps recorded in method implementations of the present disclosure can be executed in different orders and/or in parallel. In addition, the method implementations may include additional steps and/or omit the execution of the steps shown. The scope of the present disclosure is not limited in this aspect.

The term “include” and its variants as used herein mean widespread inclusion, namely, “including but not limited to”. The term “based on” is “based at least in part on”. The term “one embodiment” means “at least one embodiment”. The term “another embodiment” means “at least another embodiment”. The term “some embodiments” means “at least some embodiments”. Relevant definitions of other terms will be given in the description below.

The concepts such as “first” and “second” mentioned in the present disclosure are only used to distinguish different apparatuses, modules, or units, and are not intended to limit the order or interdependence of the functions performed by these apparatuses, modules, or units.

The modifications of “one” and “plurality” mentioned in the present disclosure are indicative rather than restrictive, and those skilled in the art should understand that unless otherwise clearly stated in the context, they should be understood as “one or more”.

Messages or names of information interacted between a plurality of apparatuses in the implementations of the present disclosure are only for illustrative purposes and are not intended to limit the messages or the scope of the information.

Before use of the technical solutions disclosed in the plurality of embodiments of the present disclosure, users should be informed of the type, scope of use, usage scenarios, and the like of personal information involved in the present disclosure in accordance with relevant laws and regulations in an appropriate manner, so as to obtain authorization from the users.

For example, in response to that an active request of a user has been received, prompt information is sent to the user to clearly remind the user that personal information of the user needs to be involved in an operation requested to be executed. Thus, the user can independently select whether to provide the personal information to software or hardware such as an electronic device, an application program, a server, or a storage medium that performs the operation of the technical solutions of the present disclosure according to the prompt information.

As an alternative but non-restrictive implementation, in response to that an active request of a user has been received, prompt information is sent to the user through, for example, a pop-up window where the prompt information can be presented in text. In addition, the pop-up window can also carry a selection control for the user to select whether to “agree” or “refuse” to provide the personal information to the electronic device.

The above notification and the above user authorization obtaining process are only illustrative and do not constitute a limitation on the implementations of the present disclosure. Other methods that meet the relevant laws and regulations can also be applied to the implementations of the present disclosure.

Data involved in the technical solutions (including but not limited to the data itself, and obtaining or use of the data) should comply with the requirements of corresponding laws and regulations and relevant provisions.

A display mode for a specific effect is generally fixed, which makes the display effect of short videos added with the same effect similar and lack novelty. Moreover, the monotonous display effect cannot well meet the personalized needs of users, lacking fun.

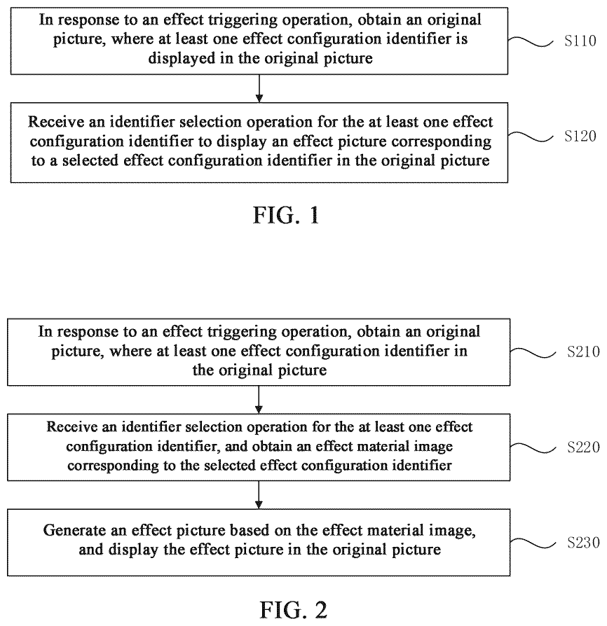

FIG. 1 is a flowchart of a method for effect processing according to an embodiment of the present disclosure. This embodiment of the present disclosure is applicable to a situation for effect processing. The method can be performed by an apparatus for effect processing. The apparatus can be implemented in the form of software and/or hardware. Alternatively, the apparatus is implemented through an electronic device. The electronic device can be a mobile terminal, a personal computer (PC) end, a server, or the like.

As shown in FIG. 1, the method for effect processing of this embodiment may include:

S110. In response to an effect triggering operation, an original picture is obtained. At least one effect configuration identifier is displayed in the original picture.

The effect triggering operation can be understood as an operation used for activating a target effect. In this embodiment of the present disclosure, the target effect can be understood as a triggered effect, specifically used for generating an effect picture and displaying the effect picture in the original picture.

There are many forms of effect triggering operations. According to types, operation modes may include contact operation and non-contact operation. In a case that the effect triggering operation is the contact operation, the effect triggering operation can be generated by performing a preset operation mode on a preset effect triggering control. The effect triggering control can be a virtual identifier or touch region set on a software interface, or a physical control. The preset operation mode may be click, press, hover, slide, or the like.

In a case that the effect triggering operation is the non-contact operation, the effect triggering operation can be generated by triggering according to a voice, a gesture, a preset time triggering condition, and a preset event.

The original picture can be understood as a picture before the target effect is applied. The original picture can be obtained by uploading images or videos, or by capturing images in real time with a camera apparatus, or by recording video frames with the camera apparatus. Picture content of the original picture can be determined according to an actual situation. In this embodiment of the present disclosure, no limitation will be made on the content presented in the original picture.

The effect configuration identifier can be understood as an interaction identifier for indicating a configuration mode for an effect picture. In this embodiment of the present disclosure, the configuration mode for the effect picture may be configuration of picture display elements in the effect picture, configuration of a picture style of the effect picture, or configuration of a display mode for the effect picture in the original picture. The configuration of the effect picture may be configuration of a partial picture region of the effect picture or configuration of a whole picture region of the effect picture.

Alternatively, the effect configuration identifier is used for indicating a picture constitution element in the effect picture; and the effect picture corresponding to the effect configuration identifier includes the picture constitution element indicated by the effect configuration identifier. Exemplarily, the effect configuration identifier may be an identifier composed of a schematic diagram of the picture constitution element in the effect picture.

In this embodiment of the present disclosure, the number of the effect configuration identifier may be one or more. The number of the effect configuration identifier can be set according to actual situations. No specific limitation will be made on this. The display mode of the effect configuration identifier in the original picture may be displaying all the effect configuration identifiers, or displaying some of the effect configuration identifiers alternately or randomly at a time.

In response to the effect triggering operation, the original picture is obtained; a preset number of effect configuration identifiers are randomly displayed in the original picture; and each effect configuration identifier is switched for displaying at a preset frequency. For example, in response to the effect triggering operation, a mode for obtaining the original picture may be in response to an effect identifier selection operation for at least one effect identifier displayed in an effect display interface and an effect activation operation inputted for the selected effect identifier, activating the camera apparatus to capture the original picture.

S120. An identifier selection operation for the at least one effect configuration identifier is received, and an effect picture corresponding to a selected effect configuration identifier is displayed in the original picture.

In this embodiment of the present disclosure, a selection mode for effect configuration identifiers may be selecting each effect configuration identifier separately, or selecting two or more effect configuration identifiers in a batch. Therefore, an identifier selection operation for a single effect configuration identifier may be received, or an identifier selection operation for a plurality of effect configuration identifiers may be received.

Exemplarily, a preset number of effect configuration identifiers may be displayed in the original picture. Thus, the selected effect configuration identifier is determined by selecting or switching one or more effect configuration identifiers among the currently displayed effect configuration identifiers. The selection triggering operation or switching triggering operation for the effect configuration identifiers may be a triggering operation for the effect configuration identifiers by touching, or a triggering operation detected in the original picture.

Exemplarily, a set of effect configuration identifiers (e.g. 2 or 3) can be displayed in the original picture at a time, and the displayed effect configuration identifiers can be randomly switched at a preset frequency. When an identifier selection operation for a set of effect configuration identifiers is received, an effect picture corresponding to the set of effect configuration identifiers is displayed in the original picture. For example, in a case that a live object is included in the original picture, when a preset selection action of the live object is detected, an effect configuration identifier corresponding to the preset selection action is used as the selected effect configuration identifier. The preset selection action may be nodding, opening the mouth, gesturing, blinking, and the like.

There are several modes for displaying the effect picture in the original picture. For example, the effect picture is fused into at least a portion of a picture region in the original picture for displaying. A mode for fusing the effect picture with the original picture may be replacing or covering pixel values of pixel points in at least a portion of the picture region in the original picture with pixel values of pixel points of the effect picture for displaying; or, performing summation, weighted summation, multiplication, or weighted multiplication on pixel values of pixel points in at least a portion of the picture region in the original picture image, and then performing picture fusion for displaying.

To not affect a mainly displayed content in the original picture, alternatively, the effect picture corresponding to the selected effect configuration identifier is displayed in the original picture as a background image of the original picture.

Alternatively, the effect picture is displayed in the original picture as a decorative picture in a background region of the original picture. For example, the effect picture may be in the form of a decorative picture or a pendant.

Alternatively, the effect picture is displayed in the original picture as an interaction picture of a target interaction subject in the original picture. For example, the effect picture may be displayed in the form of an imaginary bubble, or in the form of a wearable, or in the form of a decorative picture applied to the target interaction subject.

According to the technical solution of this embodiment of the present disclosure, an original picture to be applied with an effect is obtained responding to an effect triggering operation, and the original picture before effect application may be displayed, so that a user may view different effects before and after the effect application. One or more effect configuration identifiers are displayed in the original picture, which provides the user with a way for interaction. Thus, an identifier selection operation for at least one effect configuration identifier is received; an interaction behavior of a user for an effect configuration identifier is associated with the effect picture; and an effect picture corresponding to a selected effect configuration identifier is displayed in the original picture, thereby achieving linkage between the effect configuration identifier and the effect picture, supporting differentiated displaying of the effect picture among different users or under different interaction behaviors, increasing the fun of interaction, meeting a personalized effect generation need of the user, enriching the technical effect of a picture display effect, and greatly enhancing the user experience.

FIG. 2 is a flowchart of another method for effect processing according to an embodiment of the present disclosure. This embodiment explains how to generate an effect picture based on any alternative technical solution in the embodiments of the present disclosure. Alternatively, an effect picture corresponding to a selected effect configuration identifier is displayed in the original picture, and it includes: an effect material image corresponding to the selected effect configuration identifier is obtained; an effect picture is generated based on the effect material image; and the effect picture is displayed in the original picture. The specific implementation may be found in the description of this embodiment. Technical features that are the same or similar to those in the previous embodiment will not be elaborated here.

As shown in FIG. 2, the method for effect processing of this embodiment may include:

S210. In response to an effect triggering operation, an original picture is obtained. At least one effect configuration identifier is displayed in the original picture.

S220. An identifier selection operation for the at least one effect configuration identifier is received, and an effect material image corresponding to the selected effect configuration identifier is obtained.

The effect material image can be understood as an image that can be used for providing generation materials for the effect picture. A correspondence relationship exists between an effect configuration identifier and an effect material image. The relationship between the effect configuration identifier and the effect material image can be one-to-one or one-to-many. Exemplarily, one or more material libraries can be set for each effect configuration identifier in advance. Each material library may store one or more effect material images.

Alternatively, an effect material image corresponding to a selected effect configuration identifier is obtained, and it includes: a preset material library corresponding to the selected effect configuration identifier, and the effect material image corresponding to the selected effect configuration identifier is obtained from the preset material library. The preset material library stores at least one effect material image.

The preset material library corresponding to the selected effect configuration identifier may be determined according to the effect configuration identifier and a pre-established correspondence relationship between the effect configuration identifier and the effect material image. In a case that one effect configuration identifier corresponds to a plurality of preset material libraries, one preset material library may be randomly selected from the plurality of preset material libraries corresponding to the effect configuration identifier, or one preset material library may be randomly selected from the plurality of preset material libraries corresponding to the effect configuration identifier by polling.

Alternatively, a mode for obtaining the effect material image corresponding to the selected effect configuration identifier from the preset material library may be random obtaining, or in accordance with a preset obtaining priority of the effect material image, or achieved by polling.

S230. An effect picture is generated based on the effect material image, and the effect picture is displayed in the original picture.

From the above content, it can be seen that the obtained effect material image may be one or more. A mode for generating the effect picture based on the effect material image may be generating the effect picture based on all or some of image regions of the effect material image.

Alternatively, in a case that one effect material image is obtained, the effect material image may be used as the effect picture, or some of image regions in the effect material image may be segmented, and the effect picture can be generated based on the segmented image regions.

Alternatively, in a case that a plurality of effect material images is obtained, the plurality of effect material images may be spliced or fused to obtain the effect picture. Alternatively, for at least a portion of the effect material images, some image regions in each effect material image can be segmented, and the segmented partial image regions and the effect material images (if any) that do not need to be segmented can be spliced or fused to generate the effect picture.

According to the technical solution of this embodiment of the present disclosure, an effect material image corresponding to the selected effect configuration identifier is obtained through an identifier selection operation performed by a user on at least one effect configuration identifier, thereby achieving association between the effect configuration identifier and the effect material image. Different effect material images may be distinguished by the effect configuration identifiers, so that the effect picture generated based on the effect material images are different too. Moreover, the effect material images provide generation materials for the effect picture, which to an extent ensures the generation efficiency of effect pictures and the picture display effect.

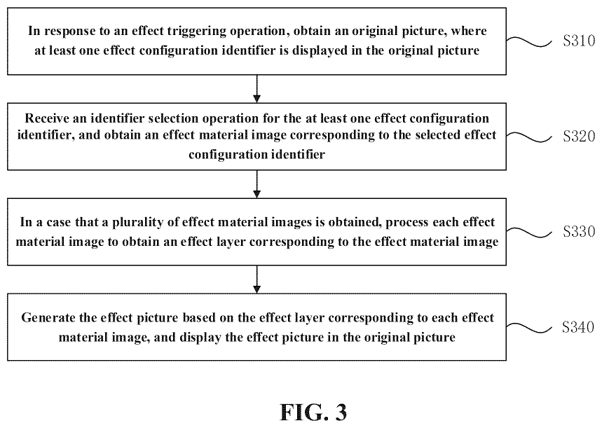

FIG. 3 is a flowchart of another method for effect processing according to an embodiment of the present disclosure. This embodiment explains how to generate an effect picture using effect material images based on any alternative technical solution in the embodiments of the present disclosure. Alternatively, an effect picture is generated based on the effect material image, which includes: In a case that a plurality of effect material images is obtained, each effect material image is processed to obtain an effect layer corresponding to the effect material image; and the effect picture is generated based on the effect layer corresponding to each effect material image. The specific implementation can be found in the description of this embodiment. Technical features that are the same or similar to those in the previous embodiment will not be elaborated here.

As shown in FIG. 3, the method for effect processing of this embodiment may include:

S310. In response to an effect triggering operation, an original picture is obtained. At least one effect configuration identifier is displayed in the original picture.

S320. An identifier selection operation for the at least one effect configuration identifier is received, and an effect material image corresponding to the selected effect configuration identifier is obtained.

S330. In a case that a plurality of effect material images is obtained, each effect material image is processed to obtain an effect layer corresponding to the effect material image.

In this embodiment of the present disclosure, modes for processing the various effect material images may be the same or different. Exemplarily, the mode for processing the effect material image may include matting processing, image segmentation processing, image fusion processing, image completion processing, stylization processing, image effect processing, and the like. The image fusion includes but is not limited to at least one of fusion of image cutting and pasting, alpha channel fusion, multi-band fusion, and the like.

Alternatively, the image completion includes but is not limited to algorithm-layer image completion and/or rendering-layer image completion. The rendering-layer image completion may include at least one of edge detection, squeezing and stretching, blurring, noise wave processing, and the like.

Alternatively, the stylization includes but is not limited to at least one of oil painting stylization, ink painting stylization, or cyberpunk stylization. The specific image processing mode used may include but is not limited to outlining and/or tone mapping.

Alternatively, the image effect processing includes but is not limited to at least one of depth of field processing, flooding, distortion, filtering, igniting, graining, bokeh blurring, lens flare, motion blurring, fog effect processing, and the like.

Alternatively, a correspondence relationship between each effect configuration identifier and an image processing mode may be established in advance, and then the image processing mode for each effect material image can be determined according to the effect configuration identifier corresponding to the effect material image. In addition, the image processing mode can be set for each effect material image.

S340. The effect picture is generated based on the effect layer corresponding to each effect material image, and the effect picture is displayed in the original picture.

In this embodiment of the present disclosure, there are various modes for generating the effect picture using a plurality of effect layers. Alternatively, the effect picture is obtained by stacking effect layers corresponding to a plurality of effect material images. A picture display position and a picture display size of the effect layer corresponding to each effect material image in the original picture may be determined, and the effect layers corresponding the plurality of effect material images are stacked based on the picture display position and picture display size of each effect layer, to obtain the effect picture.

The effect picture is displayed in the original picture, which may be achieved by setting camera parameters corresponding to the effect layers according to the picture display positions and picture display sizes of the effect layers in the original picture, and then rendering the effect layers into the original picture based on the camera parameters.

Altematively, a mode for stacking the effect layers corresponding to the plurality of effect material images may be achieved by setting the transparencies of the plurality of effect layers. Or, the mode may be achieved by layer fusion on pixel values of pixel points of stacked regions in the plurality of effect layers through summation, weighted summation, multiplication, or weighted multiplication.

According to the technical solution of this embodiment of the present disclosure, each effect material image among the plurality of effect material images is processed to obtain a plurality of effect layers, so that an effect picture is generated based on the plurality of effect layers, thereby achieving targeted processing on the plurality of effect material images. Furthermore, content of the plurality of effect material images can be fused in the effect picture, so that the effect picture can contain information of the plurality of effect material images, which enriches the effect picture display effect.

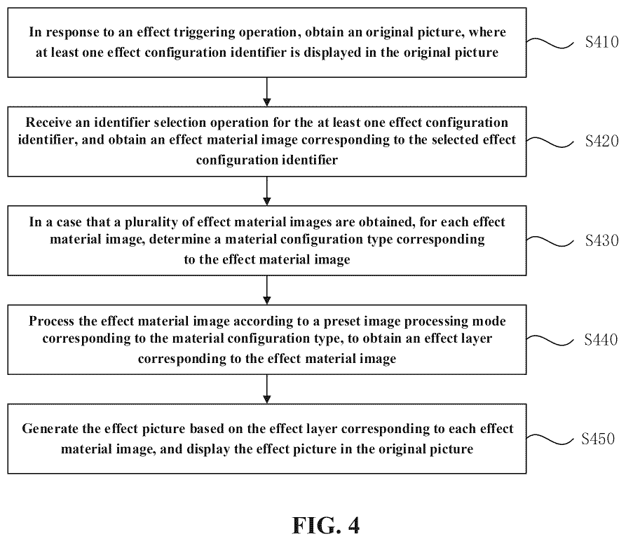

FIG. 4 is a flowchart of yet another method for effect processing according to an embodiment of the present disclosure. This embodiment explains how to obtain an effect layer corresponding to the effect material image based on any alternative technical solution in the embodiments of the present disclosure. Alternatively, each effect material image is processed to obtain an effect layer corresponding to the effect material image, and it includes: For each effect material image, a material configuration type corresponding to the effect material image is determined; the effect material image is processed according to a preset image processing mode corresponding to the material configuration type to obtain the effect layer corresponding to the effect material image. The specific implementation can be found in the description of this embodiment. Technical features that are the same or similar to those in the previous embodiment will not be elaborated here.

As shown in FIG. 4, the method for effect processing of this embodiment may include:

S410. In response to an effect triggering operation, an original picture is obtained. At least one effect configuration identifier is displayed in the original picture.

S420. An identifier selection operation for the at least one effect configuration identifier is received, and an effect material image corresponding to the selected effect configuration identifier is obtained.

S430. In a case that a plurality of effect material images is obtained, for each effect material image, a material configuration type corresponding to the effect material image is determined.

The material configuration type may be used for indicating that the effect material image is used for configuring which character in the effect picture. In this embodiment of the present disclosure, alternatively, the material configuration type may include a foreground configuration type and a background configuration type. The foreground configuration type may be understood as a material type used for generating foreground information of the effect picture. The background configuration type may be understood as a material type used for generating background information of the effect picture. Exemplarily, the foreground configuration type may include a foreground main type and a foreground sub type. The advantage of this setting is that in a case that the foreground information in the effect picture includes a plurality of foreground objects, a foreground main body and a foreground sub body may be distinguished.

Alternatively, a correspondence relationship between the picture display position of the effect configuration identifier and the material configuration type is set in advance. A material configuration type corresponding to the effect material image is determined, and it includes a picture display position of the effect configuration identifier corresponding to the effect material image in the original picture is determined; and the material configuration type corresponding to the effect material image is determined according to the picture display position.

Alternatively, a correspondence relationship between the effect material image and the material configuration type is set in advance, or a correspondence relationship between the preset material library and the material configuration type is set in advance, and the material configuration type corresponding to the effect material image is determined according to the preset material library where the effect material image is located.

S440. The effect material image is processed according to a preset image processing mode corresponding to the material configuration type to obtain an effect layer corresponding to the effect material image.

In this embodiment of the present disclosure, the image processing modes corresponding to different material configuration types may be the same or different. When two or more of the above image processing modes are used to process effect material images, the various image processing modes for different effect material images may be completely different, completely the same, or partially different and partially the same.

Alternatively, in a case that the material configuration type is a foreground configuration type, a target foreground element in the effect material image is determined according to the selected effect configuration identifier corresponding to the effect material image; and foregrounding processing is for the effect material image based on the target foreground element to obtain an effect layer including the target foreground element. The foregrounding processing includes at least one of image segmentation processing, matting processing, image fusion processing, and stylization processing.

The target foreground element may be understood as an element used for generating a foreground picture of the effect picture. The target foreground element may be an image element of interest in the effect material image.

Alternatively, the effect configuration identifier can be used for identifying the image element of interest in the effect material image. Thus, the target foreground element in the effect material image is extracted according to the effect configuration identifier corresponding to the effect material image.

Exemplarily, by an image segmentation algorithm or pre-trained image segmentation model, an image region including the target foreground element in the effect material image can be obtained by segmentation, or an image region including the target foreground element in the effect material image can be extracted by matting, to obtain the effect layer. The image segmentation model can be a deep learning model, such as a convolutional neural network.

For example, the effect configuration identifier may be a bunny-patterned identifier; the effect material image corresponding to the effect configuration identifier may be an image including a bunny; and the target foreground element may be a bunny. Thus, a region, including the bunny, in the effect material image may be segmented out as the effect layer used for generating the foreground information of the effect picture.

Alternatively, in a case that the material configuration type is a background configuration type, backgrounding processing is for the effect material image to obtain an effect layer having a preset size and used as a background image of the effect picture. The backgrounding processing at least includes image completion processing and stylization processing.

In this embodiment of the present disclosure, to ensure the display effect on the background image, the effect layer used as the background image of the effect picture can be processed to the preset size. A specific value of the preset size may be determined according to an actual need. No limitation will be made on the specific value. For example, the preset size may be a size of a terminal screen adapted to display the original picture. Alternatively, the preset size is greater than or equal to the size of the terminal screen adapted to display the original picture.

Alternatively, in a case that the material configuration type is a background configuration type, the effect material image is stylized, and the effect material image is scaled to a preset size to obtain an effect layer used as a background image of the effect picture. Altematively, a foreground region of the effect material image is removed, and an effect layer having a preset size and used as a background image of the effect picture is generated by image completion.

S450. The effect picture is generated based on the effect layer corresponding to each effect material image, and the effect picture is displayed in the original picture.

According to the technical solution of this embodiment of the present disclosure, material configuration types corresponding to the plurality of obtained effect material images are determined; and the effect material images are processed according to image processing modes corresponding to the material configuration types, thereby achieving classification of the effect material images. Different image processing modes can be used to process the plurality of effect material images, thereby enriching the form of the obtained effect layer, and further enriches the image display effect on the effect picture.

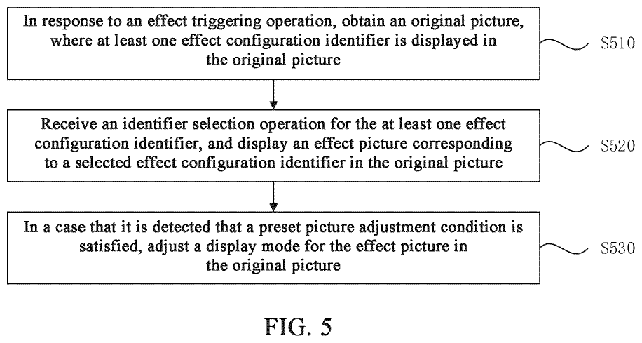

FIG. 5 is a flowchart of still another method for effect processing according to an embodiment of the present disclosure. This embodiment further achieves a function of interaction with an effect picture based on any alternative technical solution in the embodiments of the present disclosure. Alternatively, the method for effect processing further includes in a case that detecting that a preset picture adjustment condition is satisfied, a display mode for the effect picture in the original picture is adjusted. The specific implementation may be found in the description of this embodiment. Technical features that are the same or similar to those in the previous embodiment will not be elaborated here.

As shown in FIG. 5, the method for effect processing of this embodiment may include:

S510. In response to an effect triggering operation, an original picture is obtained. At least one effect configuration identifier is displayed in the original picture.

S520. An identifier selection operation for the at least one effect configuration identifier is received, and an effect picture corresponding to a selected effect configuration identifier is displayed in the original picture.

S530. In a case that it is detected that a preset picture adjustment condition is satisfied, a display mode for the effect picture in the original picture is adjusted.

The picture adjustment triggering operation can be understood as an operation used for adjusting the display mode for the effect picture in the original picture after being triggered. Similarly, the picture adjustment triggering operation can be a preset triggering operation.

Alternatively, the preset picture adjustment condition includes, but is not limited to: a preset picture adjustment triggering operation for the effect picture, and/or current time reaches picture adjustment time for the effect picture. Exemplarily, the picture adjustment triggering operation may be a preset adjustment triggering action performed by a target interaction subject in the original picture, such as rotating the head or turning around, or a touch operation for an effect picture input, or a control triggering operation preformed on a preset picture adjustment control.

There are several expression forms of a picture adjustment control, such as a slider, a key, or a disk. Alternatively, the picture adjustment control may be a touch region used for entering touch trajectory.

Alternatively, adjusting the display mode for the effect picture in the original picture may be adjusting at least one of a display size, display position, display angle, display style, and the like of the effect picture in the original picture.

Alternatively, a motion function corresponding to the effect picture is set in advance, and the display mode for the effect picture in the original picture is adjusted based on the motion function. Namely, if a condition of adjusting the display mode for the effect picture in the original picture through the motion function is satisfied, the display mode for the effect picture in the original picture may be adjusted based on the motion function. Exemplarily, the motion function may be a cyclic motion function. For example, the motion function can be a Ping-Pong function.

According to the technical solution of this embodiment of the present disclosure, the display mode for the effect picture in the original picture may be adjusted by responding to the picture adjustment triggering operation for the effect picture, thereby achieving interactions between a user and an effect picture, further enriching the display effect on the effect picture, and enhancing the user interaction experience.

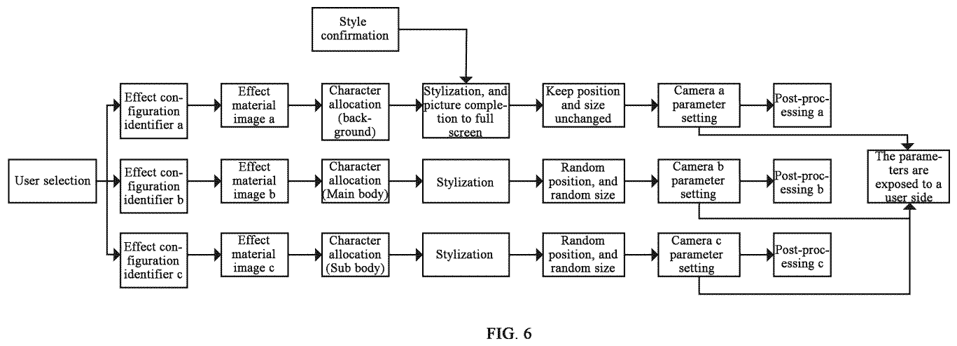

FIG. 6 is a flowchart of an alternative example of a method for effect processing according to an embodiment of the present disclosure. By use of the method for effect processing of this embodiment, according to a plurality of effect configuration identifiers selected randomly by a user, a full-screen image, i.e. an effect picture, including content corresponding to the effect configuration identifiers can be generated. Then, the full-screen image can be displayed in the form of a background image in the original picture. Through a series of processing shown in FIG. 6, a visual effect of differentiated displaying of the effect picture among different users or under different interaction behaviors can be achieved.

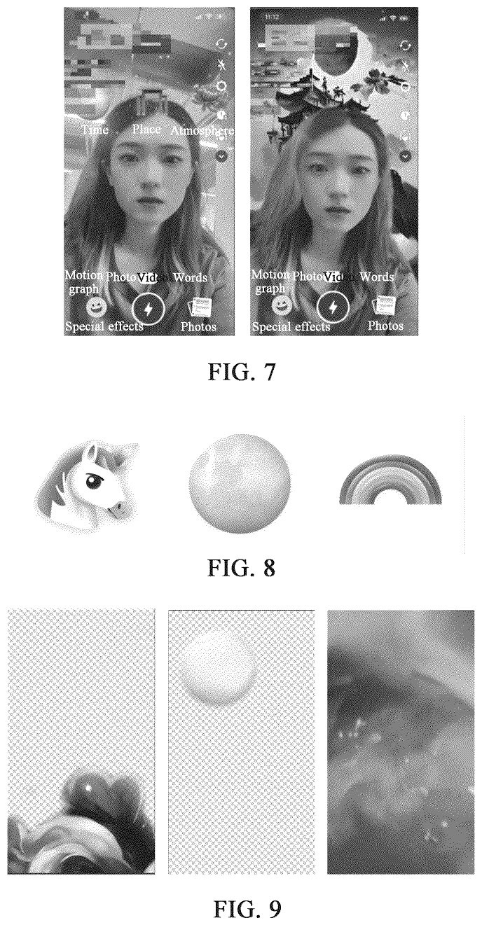

As shown in FIG. 7, by use of the method for effect processing provided in this embodiment of the present disclosure, a personalized effect picture may be generated by selecting three effect configuration identifiers (moon, the building, and flower identifiers in FIG. 7) displayed in an original picture (see FIG. 7 on the left-hand side) through an interaction behavior of a user, and the effect picture (see FIG. 7 on the right-hand side) may be displayed in a background region in the original picture.

Continuing to refer to FIG. 6, the method may include:

Firstly, in response to an effect activation operation for a target effect input, a camera is activated for video taking. A captured original picture is displayed, as shown in FIG. 7. Three effect configuration identifiers (the moon, building, and flower identifiers in FIG. 7) may be displayed in the original picture. In response to a nodding operation of the user, the three effect configuration identifiers can be randomly switched for displaying. When a blinking operation of the user is received, the three effect configuration identifiers displayed in the original picture are used as effect configuration identifiers selected by the user. The effect configuration identifiers selected by the user can be represented as effect configuration identifier a, effect configuration identifier b, and effect configuration identifier c. It can be understood that the combination of the effect configuration identifiers selected by the user is associated with a selection operation of the user, and the effect configuration identifiers selected by the user may be various. For example, the selected effect configuration identifiers may be unicorn, moon, and rainbow identifiers as shown in FIG. 8.

Then, effect material image a, effect material image b, and effect material image c corresponding to effect configuration identifier a, effect configuration identifier b, and effect configuration identifier c are obtained respectively, and characters are allocated to effect material image a, effect material image b, and effect material image c. For example, characters and cameras corresponding to effect material image a, effect material image b, and effect material image c are allocated according to a rule. A texture drawing configuration table required for drawing effect layers corresponding to effect material image a, effect material image b, and effect material image c is generated, and textures are drawn in sequence according to the texture drawing configuration table. For example, the effect layer corresponding to effect material image a is used as background layer a; the effect layer corresponding to effect material image b is used as a foreground main layer b; and the effect layer corresponding to effect material image c is used as a foreground sub layer c. Following the previous example, the unicorn used as the foreground main layer; the moon used as the foreground sub layer, and the rainbow can be used to generate the background layer.

Effect material image a, effect material image b, and effect material image c are stylized according to a style to be confirmed. Since effect material image a needs to generate the effect layer used as the background image of the effect picture, effect material image a maybe then completed, causing the effect layer used as background image of the effect picture can be displayed in a full-screen manner. As shown in FIG. 9, the unicorn is used as the effect layer generated by a foreground main body (see FIG. 9 on the left-hand side); the moon is used as the effect layer generated by a foreground sub body (see FIG. 9 in the middle); and the rainbow generates the effect layer used as the background image of the effect picture (see FIG. 9 on the right-hand side).

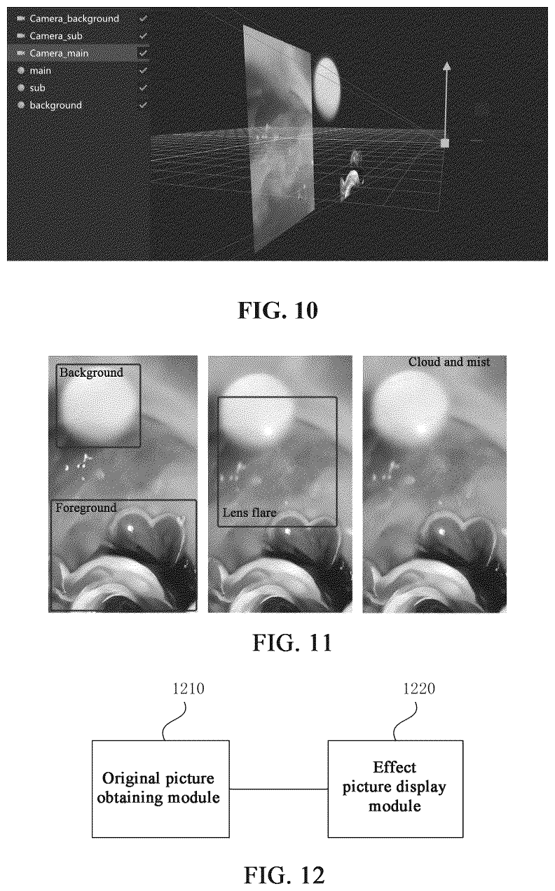

Display positions of background layer a, foreground main layer b, and foreground sub layer c in the original picture or in a screen are determined. Exemplarily, as shown in FIG. 10, the display position and size of background layer a can remain unchanged. The display positions and sizes of foreground main layer b and foreground sub layer c can be randomly configured.

Based on this, camera parameters of background layer a, foreground main layer b, and foreground sub layer c can be set separately, namely, camera parameter a corresponding to background layer a is set; camera parameter b corresponding to the background layer b is set, camera parameters c corresponding to background layer c is set, to render the effect picture in the screen based on the camera parameters corresponding to the plurality of effect layers.

Finally, each effect layer can be further post-processed to enhance the image display effect. For example, a foreground main body in the effect picture may be used as a foreground object, and a foreground sub body may be used as a background object. The foreground object is closer to the camera than the background object, and visual layer looks larger. One or more effect layers can be further post-processed, to show different picture effects. As shown in FIG. 11, an effect picture can be added with lens flare and/or clouds.

In addition, the camera parameters can be exposed to a user side to dynamically map the positions of the plurality of effect layers in a screen space according to the input camera parameters, thereby providing the interaction experience. For example, the display positions of the effect layers in the screen can be dynamically adjusted according to the input camera parameters to generate dynamic textures. In this embodiments of the present disclosure, the head of the user can be rotated to adapt to an angle change. Alternatively, a touch sliding operation is entered into a preset touch region in the screen. Alternatively, a sliding operation for a sliding control is associated with the camera parameters, to achieve a function of changing a display mode based on an effect picture controlled by the user, thereby providing a more real picture feeling and enhancing the immersive user experience.

By use of the above technical solution, different elements can be processed according to character definitions, and post-processing with different configurations can be for content, which highlights a subject of an effect picture, achieving a unified style and a richer visual effect, and showing a more realistic picture feeling.

FIG. 12 is a schematic structural diagram of an apparatus for effect processing according to an embodiment of the present disclosure. As shown in FIG. 12, the apparatus includes: an original picture obtaining module 1210 and an effect display module 1220.

The original picture obtaining module 1210 is configured to in response to an effect triggering operation, obtain an original picture, wherein at least one effect configuration identifier is displayed in the original picture; and the effect picture display module 1220 is configured to receive an identifier selection operation for the at least one effect configuration identifier to display an effect picture corresponding to a selected effect configuration identifier in the original picture.

According to the technical solution of this embodiment of the present disclosure, an original picture to be applied with an effect is obtained responding to an effect triggering operation, and the original picture before effect application can be displayed, so that a user can view different effects before and after the effect application. One or more effect configuration identifiers are displayed in the original picture, which provides the user with a way for interaction. Thus, an identifier selection operation for at least one effect configuration identifier is received; an interaction behavior of a user for an effect configuration identifier is associated with the effect picture; and an effect picture corresponding to a selected effect configuration identifier is displayed in the original picture, thereby achieving linkage between the effect configuration identifier and the effect picture, supporting differentiated displaying of the effect picture among different users or under different interaction behaviors, increasing the fun of interaction, meeting a personalized effect generation need of the user, enriching the technical effect of a picture display effect, and greatly enhancing the user experience.

Based on any of the alternative technical solutions in the embodiments of the present disclosure, alternatively, the effect picture display module displays the effect picture corresponding to the selected effect configuration identifier in the original picture in the following way: displaying the effect picture corresponding to a selected effect configuration identifier in the original picture as a background image of the original picture.

Based on any of the alternative technical solutions in the embodiments of the present disclosure, alternatively, the effect picture display module displays the effect picture corresponding to the selected effect configuration identifier in the original picture in the following way obtaining an effect material image corresponding to the selected effect configuration identifier, generating an effect picture based on the effect material image, and displaying the effect picture in the original picture.

Based on any of the alternative technical solutions in the embodiments of the present disclosure, alternatively, the effect picture display module generates the effect picture based on the effect material image in the following way: in a case that a plurality of effect material images are obtained, performing image processing on each effect material image to obtain an effect layer corresponding to the effect material image, and generating the effect picture based on the effect layer corresponding to each effect material image.

Based on any of the alternative technical solutions in the embodiments of the present disclosure, alternatively, the effect picture display module performs image processing on each effect material image to obtain the effect layer corresponding to the effect material image in the following way for each effect material image, determining a material configuration type corresponding to the effect material image; and performing the image processing on the effect material image according to a preset image processing mode corresponding to the material configuration type, to obtain the effect layer corresponding to the effect material image.

Based on any of the alternative technical solutions in the embodiments of the present disclosure, alternatively, the effect picture display module performs the image process on the effect material image according to the preset image processing mode corresponding to the material configuration type to obtain the effect layer corresponding to the effect material image in the following way: in a case that the material configuration type is a foreground configuration type, determining a target foreground element in the effect material image according to the selected effect configuration identifier corresponding to the effect material image; and performing foregrounding processing on the effect material image based on the target foreground element, to obtain an effect layer including the target foreground element. The foregrounding processing includes at least one of matting processing, image segmentation processing, image fusion processing, and stylization processing.

Based on any of the alternative technical solutions in the embodiments of the present disclosure, alternatively, the effect picture display module performing the image processing on the effect material image according to the preset image processing mode corresponding to the material configuration type to obtain the effect layer corresponding to the effect material image in the following way: in a case that the material configuration type is a background configuration type, performing backgrounding processing on the effect material image to obtain an effect layer having a preset size and used as a background image of the effect picture. The backgrounding processing at least includes image completion processing and stylization processing.

Based on any of the alternative technical solutions in the embodiments of the present disclosure, alternatively, the effect picture display module generates the effect picture based on the effect layer corresponding to each effect material image in the following way: determining a picture display position and a picture display size of the effect layer corresponding to each effect material image in the original picture, and stacking the effect layers corresponding the plurality of effect material images based on the picture display position and picture display size of each effect layer, to obtain the effect picture.

Based on any of the alternative technical solutions in the embodiments of the present disclosure, alternatively, the effect picture display module obtains an effect material image corresponding to the selected effect configuration identifier in the following steps determining a preset material library corresponding to the selected effect configuration identifier, and obtaining the effect material image corresponding to the selected effect configuration identifier from the preset material library. The preset material library stores at least one effect material image.

Based on any of the alternative technical solutions in the embodiments of the present disclosure, alternatively, the apparatus for effect processing further includes: an effect displaying adjustment module, configured to: in a case that it is detected that a preset picture adjustment condition is satisfied, adjust a display mode for the effect picture in the original picture

Based on any of the alternative technical solutions in the embodiments of the present disclosure, alternatively, the effect configuration identifier is used for indicating a picture constitution element in the effect picture; and the effect picture corresponding to the effect configuration identifier includes the picture constitution element indicated by the effect configuration identifier.

The apparatus for effect processing provided according to this embodiment of the present disclosure can implement the method for effect processing provided in any embodiment of the present disclosure, and includes corresponding functional modules for implementing the method and corresponding effects.

The multiple units and modules included in the above apparatus are only divided according to a functional logic, but are not limited to the above division, as long as the corresponding functions can be achieved. In addition, the names of the multiple units and modules are only for the purpose of distinguishing and are not used to limit the protection scope of the embodiments of the present disclosure.

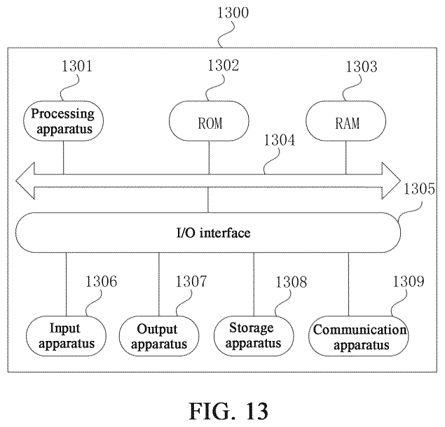

FIG. 13 is a schematic structural diagram of an electronic device according to the embodiments of the present disclosure. Reference is now made to FIG. 13 below, which illustrates a schematic structural diagram of an electronic device (namely, a terminal device or a server in FIG. 13) 1300 suitable for implementing an embodiment of the present disclosure. The terminal device in the embodiments of the present disclosure may include, but not limited to, a mobile phone, a laptop, a digital broadcast receiver, a Personal Digital Assistant (PDA), a Portable Android Device (PAD), a Portable Media Player (PMP), a mobile terminal such as a vehicle-mounted terminal (for example, a vehicle-mounted navigation terminal), and a fixed terminal such as digital television (TV) and a desktop computer. The electronic device shown in FIG. 13 is only an example and should not impose any limitations on the functionality and scope of use of the embodiments of the present disclosure.

As shown in FIG. 13, the electronic device 1300 may include a processing apparatus (such as a central processing unit and graphics processor) 1301 that can perform various appropriate actions and processing according to programs stored in a Read-Only Memory (ROM) 1302 or loaded from a storage apparatus 1308 to a Random Access Memory (RAM) 1303. Various programs and data required for operations of the electronic device 1300 may also be stored in the RAM 1303. The processing apparatus 1301, the ROM 1302, and the RAM 1303 are connected to each other through a bus 1304. An Input/output (I/O) interface 1305 is connected to the bus 1304 too.

Usually, following apparatuses can be connected to the I/O interface 1305: an input apparatus 1306 including a touch screen, a touchpad, a keyboard, a mouse, a camera, a microphone, an accelerometer, a gyroscope, and the like; an output apparatus 1307 including a Liquid Crystal Display (LCD), a speaker, a vibrator, and the like; a memory 1308 including a magnetic tape, a hard disk drive, and the like; and a communication apparatus 1309. The communication apparatus 1309 can allow the electronic device 1300 to wirelessly or wiredly communicate with other devices to exchange data. Although FIG. 13 shows the electronic device 1300 with multiple apparatuses, it should be understood that the electronic device 1300 is not required to implement or have all the apparatuses shown, and can alternatively implement or have more or fewer apparatuses.

According to the embodiments of the present disclosure, the process described in the reference flowchart above can be implemented as a computer software program. For example, the embodiments of the present disclosure include a computer program product, including a computer program carried on a non-transitory computer-readable medium, and the computer program includes program codes used for performing the methods shown in the flowcharts. In such an embodiment, the computer program may be downloaded and installed from a network through the communication apparatus 1309, or installed from the memory 1308, or installed from the ROM 1302. When the computer program is executed by the processing apparatus 1301, the above-mentioned functions defined in the methods of the embodiments of the present disclosure are executed.

Messages or names of information interacted between a plurality of apparatuses in the implementations of the present disclosure are only for illustrative purposes and are not intended to limit the messages or the scope of the information.

The electronic device provided in this embodiment of the present disclosure and the method for effect processing provided in the above embodiment belong to the same inventive concept. Technical details not fully described in this embodiment can be found in the above embodiments, and this embodiment has the same effects as the above embodiments.

The embodiments of the present disclosure provide a computer storage medium having a computer program stored thereon. Running of the program by a processor implements the method for effect processing provided in the above embodiment.

The computer-readable medium mentioned in the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage medium may include but are not limited to: an electrical connection with one or more wires, a portable computer disk, a hard disk drive, a RAM, a ROM, an Erasable Programmable Read Only Memory (EPROM) or flash memory, an optical fiber, a Compact Disc Read-Only Memory (CD-ROM), an optical storage device, a magnetic storage device or any suitable combination of the above. In the present disclosure, the computer-readable storage medium may be any tangible medium that includes or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signals can be in various forms, including but not limited to: electromagnetic signals, optical signals, or any suitable combination of the above. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but not limited to: a wire, an optical cable, a Radio Frequency (RF), and the like, or any suitable combination of the above.

In some implementations, clients and servers can communicate using any currently known or future developed network protocol such as a HyperText Transfer Protocol (HTTP), and can intercommunicate and be interconnected with digital data in any form or medium (for example, a communication network). Examples of the communication network include a Local Area Network (LAN), a Wide Area Network (WAN), an internet (such as an Internet), a point-to-point network (such as an ad hoc point-to-point network, and any currently known or future developed network.

The computer-readable medium may be included in the electronic device or exist alone and is not assembled into the electronic device.

The above computer-readable medium carries one or more programs. When the one or more programs are run by the electronic device, the electronic device is caused to: in response to an effect triggering operation, obtain an original picture, wherein at least one effect configuration identifier is displayed in the original picture; and receive an identifier selection operation for the at least one effect configuration identifier to display an effect picture corresponding to a selected effect configuration identifier in the original picture.

Computer program codes for performing the operations of the present disclosure may be written in one or more programming languages or a combination thereof. The above programming languages include but are not limited to an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a LAN or a WAN, or can be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units/modules described in the embodiments of the present disclosure can be implemented through software or hardware. The name of the units/modules do not constitute a limitation on the units/modules themselves. For example, an original picture obtaining module can also be described as “a module that obtains an original picture in response to an effect triggering operation”.

The functions described herein above may be performed, at least in part, by one or a plurality of hardware logic components. For example, non-restrictively, example hardware logic components that can be used include: a Field Programmable Gate Array (FPGA), an Application Specific Integrated Circuit (ASIC), Application Specific Standard Parts (ASSP), a System on Chip (SOC), a Complex Programmable Logic Device (CPLD), and the like.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard disk drive, a RAM, a ROM, an EPROM or flash memory, an optical fiber, a portable CD-ROM, an optical storage device, a magnetic storage device, or any suitable combinations of the above content.

According to one or more embodiments of the present disclosure, [Example I] provides a method/apparatus/system for effect processing, including: in response to an effect triggering operation, obtaining an original picture, wherein at least one effect configuration identifier is displayed in the original picture; and receiving an identifier selection operation for the at least one effect configuration identifier to display an effect picture corresponding to a selected effect configuration identifier in the original picture.

According to one or more embodiments of the present disclosure, [Example II] provides a method/apparatus/system for effect processing, further including: Alternatively, displaying as effect picture corresponding to a selected effect configuration identifier in the original picture includes: displaying the effect picture corresponding to a selected effect configuration identifier in the original picture as a background image of the original picture.

According to one or more embodiments of the present disclosure, [Example III] provides a method/apparatus/system for effect processing, further including: Alternatively, displaying an effect picture corresponding to a selected effect configuration identifier in the original picture includes: obtaining an effect material image corresponding to the selected effect configuration identifier, generating an effect picture based on the effect material image, and displaying the effect picture in the original picture.

According to one or more embodiments of the present disclosure, [Example IV] provides a method/apparatus/system for effect processing, further including: Alternatively, generating the effect picture based on the effect material image includes: in a case that a plurality of effect material images are obtained, performing image processing on each effect material image to obtain an effect layer corresponding to the effect material image; and generating the effect picture based on the effect layer corresponding to each effect material image.

According to one or more embodiments of the present disclosure, [Example V] provides a method/apparatus/system for effect processing, further including: Alternatively, performing image processing on each effect material image to obtain an effect layer corresponding to the effect material image includes for each effect material image, determining a material configuration type corresponding to the effect material image; and performing image processing on the effect material image according to the preset image processing mode corresponding to the material configuration type to obtain the effect layer corresponding to the effect material image.

According to one or more embodiments of the present disclosure, [Example VI] provides a method/apparatus/system for effect processing, further including: Altematively, performing the image processing on the effect material image according to the preset image processing mode corresponding to the material configuration type to obtain the effect layer corresponding to the effect material image includes: in a case that the material configuration type is a foreground configuration type, determining a target foreground element in the effect material image according to the selected effect configuration identifier corresponding to the effect material image; and performing foregrounding processing on the effect material image based on the target foreground element, to obtain an effect layer including the target foreground element. The foregrounding processing includes at least one of matting, image segmentation, image fusion, and stylization.

According to one or more embodiments of the present disclosure, [Example VII] provides a method/apparatus/system for effect processing, further including: Alternatively, performing image processing on the effect material image according to the preset image processing mode corresponding to the material configuration type, to obtain the effect layer corresponding to the effect material image includes: in a case that the material configuration type is a background configuration type, performing backgrounding processing on the effect material image to obtain an effect layer having a preset size and used as a background image of the effect picture. The backgrounding processing includes at least one of image completion and stylization.

According to one or more embodiments of the present disclosure, [Example VIII] provides a method/apparatus/system for effect processing, further including: Alternatively, the generating the effect picture based on the effect layer corresponding to each effect material image includes: determining a picture display position and a picture display size of the effect layer corresponding to each effect material image in the original picture, and stacking the effect layers corresponding the plurality of effect material images based on the picture display position and picture display size of each effect layer, to obtain the effect picture.

According to one or more embodiments of the present disclosure, [Example IX] provides a method/apparatus/system for effect processing, further including: Alternatively, the obtaining an effect material image corresponding to the selected effect configuration identifier includes: determining a preset material library corresponding to the selected effect configuration identifier, and obtaining the effect material image corresponding to the selected effect configuration identifier from the preset material library. The preset material library stores at least one effect material image.

According to one or more embodiments of the present disclosure, [Example X] provides a method/apparatus/system for effect processing, further including: The method for effect processing further includes: in a case that it is detected that a preset picture adjustment condition is satisfied, adjusting a display mode for the effect picture in the original picture.

According to one or more embodiments of the present disclosure, [Example XI] provides a method/apparatus/system for effect processing, further including: The effect configuration identifier is used for indicating a picture constitution element in the effect picture; and the effect picture corresponding to the effect configuration identifier includes the picture constitution element indicated by the effect configuration identifier.

According to one or more embodiments of the present disclosure, [Example XII] provides an apparatus for effect processing, including: an original picture obtaining module, configured to: in response to an effect triggering operation, obtain an original picture, wherein at least one effect configuration identifier is displayed in the original picture; and an effect picture display module, configured to: receive an identifier selection operation for the at least one effect configuration identifier, and display an effect picture corresponding to a selected effect configuration identifier in the original picture.

Although multiple operations are depicted in a specific order, this should not be understood as requiring these operations to be executed in the specific order shown or in a sequential order. In certain environments, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. Various features that are described in the context of the single embodiment may also be implemented in a plurality of embodiments separately or in any suitable sub-combinations.

Although the subject matter has been described in a language specific to structural features and/or method logical actions, it should be understood that the subject matter limited in the attached claims may not necessarily be limited to the specific features or actions described above. The specific features and actions described above are only exemplary forms for implementing the claims.

1. A method for effect processing, comprising:
in response to an effect triggering operation, obtaining an original picture, wherein at least one effect configuration identifier is displayed in the original picture; and
receiving an identifier selection operation for the at least one effect configuration identifier to display an effect picture corresponding to a selected effect configuration identifier in the original picture.

2. The method for effect processing according to claim 1, wherein displaying the effect picture corresponding to the selected effect configuration identifier in the original picture comprises:
displaying the effect picture corresponding to the selected effect configuration identifier in the original picture as a background image of the original picture.

3. The method for effect processing according to claim 1, wherein displaying the effect picture corresponding to the selected effect configuration identifier in the original picture comprises:
obtaining an effect material image corresponding to the selected effect configuration identifier and generating the effect picture based on the effect material image to display the effect picture in the original picture.

4. The method for effect processing according to claim 3, wherein generating the effect picture based on the effect material image comprises:
in a case that a plurality of effect material images is obtained, performing image processing on each effect material image to obtain an effect layer corresponding to the effect material image; and
generating the effect picture based on the effect layer corresponding to each effect material image.

5. The method for effect processing according to claim 4, wherein performing the image processing on each effect material image to obtain the effect layer corresponding to the effect material image comprises:
determining a material configuration type corresponding to the effect material image for each effect material image; and
performing image processing on the effect material image according to a preset image processing mode corresponding to the material configuration type to obtain the effect layer corresponding to the effect material image.

6. The method for effect processing according to claim 5, wherein performing the image processing on the effect material image according to the preset image processing mode corresponding to the material configuration type to obtain the effect layer corresponding to the effect material image comprises:
in a case that the material configuration type is a foreground configuration type, determining a target foreground element in the effect material image according to the selected effect configuration identifier corresponding to the effect material image; and
performing foregrounding processing on the effect material image based on the target foreground element to obtain the effect layer including the target foreground element, wherein the foregrounding processing comprises at least one of matting processing, image segmentation processing, image fusion processing, and stylization processing.

7. The method for effect processing according to claim 5, wherein performing the image processing on the effect material image according to the preset image processing mode corresponding to the material configuration type to obtain the effect layer corresponding to the effect material image comprises:
in a case that the material configuration type is a background configuration type, performing backgrounding processing on the effect material image to obtain the effect layer having a preset size and used as a background image of the effect picture, wherein the backgrounding processing comprises at least one of image completion processing and stylization processing.

8. The method for effect processing according to claim 4, wherein generating the effect picture based on the effect layer corresponding to each effect material image comprises:
determining a picture display position and a picture display size of the effect layer corresponding to each effect material image in the original picture, and stacking the effect layers corresponding to the plurality of effect material images based on the picture display position and the picture display size of each effect layer to obtain the effect picture.

9. The method for effect processing according to claim 3, wherein obtaining the effect material image corresponding to the selected effect configuration identifier comprises:
determining a preset material library corresponding to the selected effect configuration identifier to obtain the effect material image corresponding to the selected effect configuration identifier from the preset material library, wherein the preset material library stores at least one effect material image.

10. The method for effect processing according to claim 1, further comprising:
in a case of detecting that a preset picture adjustment condition is satisfied, adjusting a display mode for the effect picture in the original picture.

11. The method for effect processing according to claim 1, wherein the effect configuration identifier is used for indicating a picture constitution element in the effect picture, and the effect picture corresponding to the effect configuration identifier includes the picture constitution element indicated by the effect configuration identifier.

12. (canceled)

13. An electronic device, comprising:
at least one processor; and
a storage apparatus, configured to storage at least one program,
wherein the at least one program, when performed by the at least one processor, causes the at least one processor to:
in response to an effect triggering operation, obtain an original picture. wherein at least one effect configuration identifier is displayed in the original picture; and
receive an identifier selection operation for the at least one effect configuration identifier to display an effect picture corresponding to a selected effect configuration identifier in the original picture.

14. A non-transitory storage medium comprising computer- executable instructions, wherein the computer-executable instructions, when executed by a computer processor, cause the computer processor to:
in response to an effect triggering operation, obtain an original picture, wherein at least one effect configuration identifier is displayed in the original picture; and
receive an identifier selection operation for the at least one effect configuration identifier to display an effect picture corresponding to a selected effect configuration identifier in the original picture.

15. The device according to claim 13, wherein the at least one program causing the at least one processor to display the effect picture corresponding to the selected effect configuration identifier in the original picture comprises instructions to:
display the effect picture corresponding to the selected effect configuration identifier in the original picture as a background image of the original picture.

16. The device according to claim 13, wherein the at least one program causing the at least one processor to display the effect picture corresponding to the selected effect configuration identifier in the original picture comprises instructions to:
obtain an effect material image corresponding to the selected effect configuration identifier and generating the effect picture based on the effect material image to display the effect picture in the original picture.

17. The device according to claim 16, wherein the at least one program causing the at least one processor to generate the effect picture based on the effect material image comprises instructions to:
in a case that a plurality of effect material images is obtained, perform image processing on each effect material image to obtain an effect layer corresponding to the effect material image; and
generate the effect picture based on the effect layer corresponding to each effect material image.

18. The device according to claim 17, wherein the at least one program causing the at least one processor to perform the image processing on each effect material image to obtain the effect layer corresponding to the effect material image comprises instructions to:
determine a material configuration type corresponding to the effect material image for each effect material image; and
perform image processing on the effect material image according to a preset image processing mode corresponding to the material configuration type to obtain the effect layer corresponding to the effect material image.

19. The device according to claim 18, wherein the at least one program causing the at least one processor to perform the image processing on the effect material image according to the preset image processing mode corresponding to the material configuration type to obtain the effect layer corresponding to the effect material image comprises instructions to:
in a case that the material configuration type is a foreground configuration type, determine a target foreground element in the effect material image according to the selected effect configuration identifier corresponding to the effect material image; and
perform foregrounding processing on the effect material image based on the target foreground element to obtain the effect layer including the target foreground element, wherein the foregrounding processing comprises at least one of matting processing, image segmentation processing, image fusion processing, and stylization processing.

20. The device according to claim 19, wherein the at least one program causing the at least one processor to perform the image processing on the effect material image according to the preset image processing mode corresponding to the material configuration type to obtain the effect layer corresponding to the effect material image comprises instructions to:
in a case that the material configuration type is a background configuration type, perform backgrounding processing on the effect material image to obtain the effect layer having a preset size and used as a background image of the effect picture, wherein the backgrounding processing comprises at least one of image completion processing and stylization processing.

21. The device according to claim 17, wherein the at least one program causing the at least one processor to generate the effect picture based on the effect layer corresponding to each effect material image comprises instructions to:
determine a picture display position and a picture display size of the effect layer corresponding to each effect material image in the original picture, and stack the effect layers corresponding to the plurality of effect material images based on the picture display position and the picture display size of each effect layer to obtain the effect picture.
